(19) United States
(12) Patent Application Publication
(10) Pub. No.: US 2025/0317568 A1
(43) Pub. Date: Oct. 9, 2025

(54) ADAPTIVE CLIPPING PROCESSES FOR VIDEO AND IMAGE COMPRESSION

(71) Applicant: Tencent America LLC, Palo Alto, CA (US)

(72) Inventors: Roman CHERNYAK, Santa Clara, CA (US); Ziyue XIANG, Palo Alto, CA (US); Shan LIU, San Jose, CA (US); Biao WANG, San Jose, PA (US); Motong XU, Palo Alto, CA (US); Lien-Fei CHEN, Palo Alto, CA (US); Yifan WANG, Palo Alto, CA (US); Yonguk YOON, Palo Alto, CA (US); Tianqi LIU, Palo Alto, CA (US)

(73) Assignee: Tencent America LLC, Palo Alto, CA (US)

(21) Appl. No.: 19/172,501

(22) Filed: Apr. 7, 2025

Related U.S. Application Data
(60) Provisional application No. 63/631,408, filed on Apr. 8, 2024.

(51) Int. Cl. H04N 19/132; H04N 19/117; H04N 19/137; H04N 19/172; H04N 19/82; H04N 19/85

(52) U.S. Cl. CPC H04N 19/132; H04N 19/117; H04N 19/137; H04N 19/172; H04N 19/82; H04N 19/85

(57) ABSTRACT

Some aspects of the disclosure provide a method of video encoding. In an example, at least a clipping range to apply during an encoding of one or more pictures by a video codec is determined, the clipping range is different from a fixed clipping range that is based on a bitdepth of the video codec. The clipping range is applied to sample values of the one or more pictures to generate clipped sample values. Coded information in a bitstream is generated based on the clipped sample values. An inclusion/exclusion of a syntax element indicative of the clipping range in the bitstream is determined based on a codec configuration of the video codec.

### INCORPORATION BY REFERENCE

The present application claims the benefit of priority to U.S. Provisional Application No. 63/631,408, filed on Apr. 8, 2024. The entire disclosure of the prior application is hereby incorporated by reference in its entirety.

### TECHNICAL FIELD

The present disclosure describes aspects generally related to video coding.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Image/video compression can help transmit image/video data across different devices, storage and networks with minimal quality degradation. In some examples, video codec technology can compress video based on spatial and temporal redundancy. In an example, a video codec can use techniques referred to as intra prediction that can compress an image based on spatial redundancy. For example, the intra prediction can use reference data from the current picture under reconstruction for sample prediction. In another example, a video codec can use techniques referred to as inter prediction that can compress an image based on temporal redundancy. For example, the inter prediction can predict samples in a current picture from a previously reconstructed picture with motion compensation. The motion compensation can be indicated by a motion vector (MV).

### SUMMARY

Aspects of the disclosure include bitstreams, methods and apparatuses for video encoding/decoding. In some examples, an apparatus for video encoding/decoding includes processing circuitry.

Some aspects of the disclosure provide a method of video encoding. In an example, at least a clipping range to apply during an encoding of one or more pictures by a video codec is determined, the clipping range is different from a fixed clipping range that is based on a bitdepth of the video codec. The clipping range is applied to sample values of the one or more pictures to generate clipped sample values. Coded information in a bitstream is generated based on the clipped sample values. An inclusion/exclusion of a syntax element indicative of the clipping range in the bitstream is determined based on a codec configuration of the video codec.

Some aspects of the disclosure provide a method for video decoding. In an example, a coded video bitstream is received. The coded video bitstream includes coded information of sample values of one or more pictures. At least a clipping range is determined according to one or more syntax elements in the coded video bitstream, the clipping range is different from a fixed clipping range that is based on a bitdepth of a video codec for encoding/decoding the coded information. A configuration of a coding tool in the video codec is determined based on the clipping range. The one or more pictures are reconstructed based on the video codec with the coding tool configured according to the configuration.

Some aspects of the disclosure provide a method of processing visual media data is provided. In the method, a conversion between a visual media file and a bitstream of visual media data is performed according to a format rule. In an example, the bitstream includes coded information of sample values of one or more pictures. The format rule specifies that at least a clipping range is determined according to one or more syntax elements in the coded video bitstream, the clipping range is different from a fixed clipping range that is based on a bitdepth of a video codec for processing the sample values of the one or more pictures. The format rule also specifies that a configuration of a coding tool in the video codec is determined based on the clipping range, and the one or more pictures are reconstructed based on the video codec with the coding tool configured according to the configuration.

Aspects of the disclosure also provide an apparatus for video decoding. The apparatus for video encoding including processing circuitry configured to implement any of the described methods for video decoding.

Aspects of the disclosure also provide an apparatus for video encoding. The apparatus for video encoding including processing circuitry configured to implement any of the described methods for video encoding.

Aspects of the disclosure also provide a non-transitory computer-readable medium storing instructions which, when executed by a computer, cause the computer to perform any of the described methods for video decoding/encoding.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of an example of a block diagram of a communication system.

FIG. 2 is a schematic illustration of an example of a block diagram of a decoder.

FIG. 3 is a schematic illustration of an example of a block diagram of an encoder.

FIG. 4 shows a flow chart outlining an encoding process according to some aspects of the disclosure.

FIG. 5 shows a flow chart outlining a decoding process according to some aspects of the disclosure.

FIG. 6 is a schematic illustration of a computer system in accordance with an aspect.

### DETAILED DESCRIPTION

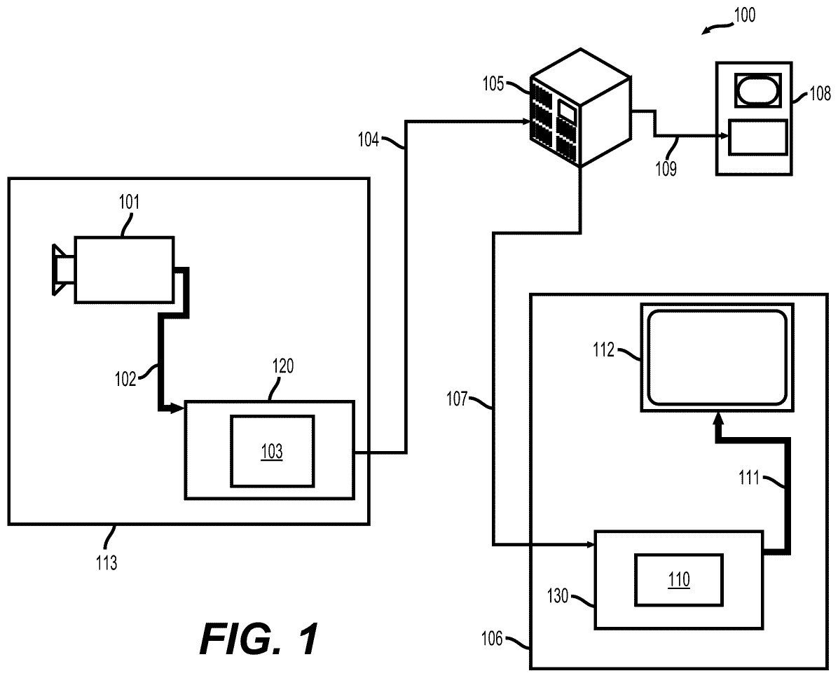

FIG. 1 shows a block diagram of a video processing system (100) in some examples. The video processing system (100) is an example of an application for the disclosed subject matter, a video encoder and a video decoder in a streaming environment. The disclosed subject matter can be equally applicable to other video enabled applications, including, for example, video conferencing, digital TV, streaming services, storing of compressed video on digital media including CD, DVD, memory stick and the like, and so on.

The video processing system (100) includes a capture subsystem (113), that can include a video source (101), for example a digital camera, creating for example a stream of video pictures (102) that are uncompressed. In an example, the stream of video pictures (102) includes samples that are taken by the digital camera. The stream of video pictures (102), depicted as a bold line to emphasize a high data volume when compared to encoded video data (104) (or coded video bitstreams), can be processed by an electronic device (120) that includes a video encoder (103) coupled to the video source (101). The video encoder (103) can include hardware, software, or a combination thereof to enable or implement aspects of the disclosed subject matter as described in more detail below. The encoded video data (104) (or encoded video bitstream), depicted as a thin line to emphasize the lower data volume when compared to the stream of video pictures (102), can be stored on a streaming server (105) for future use. One or more streaming client subsystems, such as client subsystems (106) and (108) in FIG. 1 can access the streaming server (105) to retrieve copies (107) and (109) of the encoded video data (104). A client subsystem (106) can include a video decoder (110), for example, in an electronic device (130). The video decoder (110) decodes the incoming copy (107) of the encoded video data and creates an outgoing stream of video pictures (111) that can be rendered on a display (112) (e.g., display screen) or other rendering device (not depicted). In some streaming systems, the encoded video data (104), (107), and (109) (e.g., video bitstreams) can be encoded according to certain video coding/compression standards. Examples of those standards include ITU-T Recommendation H.265. In an example, a video coding standard under development is informally known as Versatile Video Coding (VVC). The disclosed subject matter may be used in the context of VVC.

It is noted that the electronic devices (120) and (130) can include other components (not shown). For example, the electronic device (120) can include a video decoder (not shown) and the electronic device (130) can include a video encoder (not shown) as well.

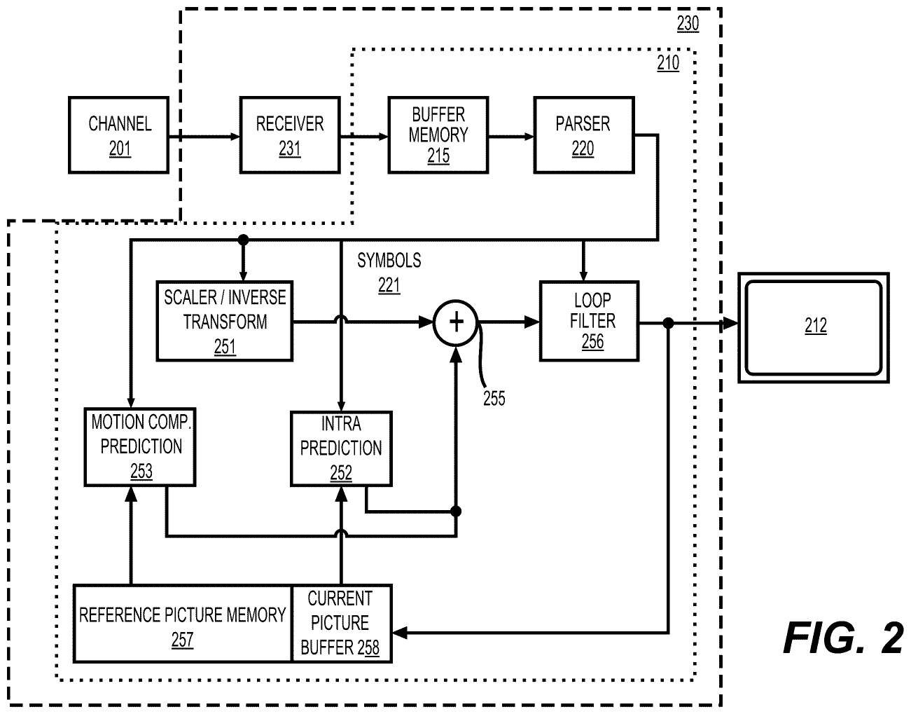

FIG. 2 shows an example of a block diagram of a video decoder (210). The video decoder (210) can be included in an electronic device (230). The electronic device (230) can include a receiver (231) (e.g., receiving circuitry). The video decoder (210) can be used in the place of the video decoder (110) in the FIG. 1 example.

The receiver (231) may receive one or more coded video sequences, included in a bitstream for example, to be decoded by the video decoder (210). In an aspect, one coded video sequence is received at a time, where the decoding of each coded video sequence is independent from the decoding of other coded video sequences. The coded video sequence may be received from a channel (201), which may be a hardware/software link to a storage device which stores the encoded video data. The receiver (231) may receive the encoded video data with other data, for example, coded audio data and/or ancillary data streams, that may be forwarded to their respective using entities (not depicted). The receiver (231) may separate the coded video sequence from the other data. To combat network jitter, a buffer memory (215) may be coupled in between the receiver (231) and an entropy decoder/parser (220) (“parser (220)” henceforth). In certain applications, the buffer memory (215) is part of the video decoder (210). In others, it can be outside of the video decoder (210) (not depicted). In still others, there can be a buffer memory (not depicted) outside of the video decoder (210), for example to combat network jitter, and in addition another buffer memory (215) inside the video decoder (210), for example to handle playout timing. When the receiver (231) is receiving data from a store/forward device of sufficient bandwidth and controllability, or from an isosynchronous network, the buffer memory (215) may not be needed, or can be small. For use on best effort packet networks such as the Internet, the buffer memory (215) may be required, can be comparatively large and can be advantageously of adaptive size, and may at least partially be implemented in an operating system or similar elements (not depicted) outside of the video decoder (210).

The video decoder (210) may include the parser (220) to reconstruct symbols (221) from the coded video sequence. Categories of those symbols include information used to manage operation of the video decoder (210), and potentially information to control a rendering device such as a render device (212) (e.g., a display screen) that is not an integral part of the electronic device (230) but can be coupled to the electronic device (230), as shown in FIG. 2. The control information for the rendering device(s) may be in the form of Supplemental Enhancement Information (SEI) messages or Video Usability Information (VUI) parameter set fragments (not depicted). The parser (220) may parse/entropy-decode the coded video sequence that is received. The coding of the coded video sequence can be in accordance with a video coding technology or standard, and can follow various principles, including variable length coding, Huffman coding, arithmetic coding with or without context sensitivity, and so forth. The parser (220) may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser (220) may also extract from the coded video sequence information such as transform coefficients, quantizer parameter values, motion vectors, and so forth.

The parser (220) may perform an entropy decoding/parsing operation on the video sequence received from the buffer memory (215), so as to create symbols (221).

Reconstruction of the symbols (221) can involve multiple different units depending on the type of the coded video picture or parts thereof (such as: inter and intra picture, inter and intra block), and other factors. Which units are involved, and how, can be controlled by subgroup control information parsed from the coded video sequence by the parser (220). The flow of such subgroup control information between the parser (220) and the multiple units below is not depicted for clarity.

Beyond the functional blocks already mentioned, the video decoder (210) can be conceptually subdivided into a number of functional units as described below. In a practical implementation operating under commercial constraints, many of these units interact closely with each other and can, at least partly, be integrated into each other. However, for the purpose of describing the disclosed subject matter, the conceptual subdivision into the functional units below is appropriate.

A first unit is the scaler/inverse transform unit (251). The scaler/inverse transform unit (251) receives a quantized transform coefficient as well as control information, including which transform to use, block size, quantization factor, quantization scaling matrices, etc. as symbol(s) (221) from the parser (220). The scaler/inverse transform unit (251) can output blocks comprising sample values, that can be input into aggregator (255).

In some cases, the output samples of the scaler/inverse transform unit (251) can pertain to an intra coded block. The intra coded block is a block that is not using predictive information from previously reconstructed pictures, but can use predictive information from previously reconstructed parts of the current picture. Such predictive information can be provided by an intra picture prediction unit (252). In some cases, the intra picture prediction unit (252) generates a block of the same size and shape of the block under reconstruction, using surrounding already reconstructed information fetched from the current picture buffer (258). The current picture buffer (258) buffers, for example, partly reconstructed current picture and/or fully reconstructed current picture. The aggregator (255), in some cases, adds, on a per sample basis, the prediction information the intra prediction unit (252) has generated to the output sample information as provided by the scaler/inverse transform unit (251).

In other cases, the output samples of the scaler/inverse transform unit (251) can pertain to an inter coded, and potentially motion compensated, block. In such a case, a motion compensation prediction unit (253) can access reference picture memory (257) to fetch samples used for prediction. After motion compensating the fetched samples in accordance with the symbols (221) pertaining to the block, these samples can be added by the aggregator (255) to the output of the scaler/inverse transform unit (251) (in this case called the residual samples or residual signal) so as to generate output sample information. The addresses within the reference picture memory (257) from where the motion compensation prediction unit (253) fetches prediction samples can be controlled by motion vectors, available to the motion compensation prediction unit (253) in the form of symbols (221) that can have, for example X, Y, and reference picture components. Motion compensation also can include interpolation of sample values as fetched from the reference picture memory (257) when sub-sample exact motion vectors are in use, motion vector prediction mechanisms, and so forth.

The output samples of the aggregator (255) can be subject to various loop filtering techniques in the loop filter unit (256). Video compression technologies can include in-loop filter technologies that are controlled by parameters included in the coded video sequence (also referred to as coded video bitstream) and made available to the loop filter unit (256) as symbols (221) from the parser (220). Video compression can also be responsive to meta-information obtained during the decoding of previous (in decoding order) parts of the coded picture or coded video sequence, as well as responsive to previously reconstructed and loop-filtered sample values.

The output of the loop filter unit (256) can be a sample stream that can be output to the render device (212) as well as stored in the reference picture memory (257) for use in future inter-picture prediction.

Certain coded pictures, once fully reconstructed, can be used as reference pictures for future prediction. For example, once a coded picture corresponding to a current picture is fully reconstructed and the coded picture has been identified as a reference picture (by, for example, the parser (220)), the current picture buffer (258) can become a part of the reference picture memory (257), and a fresh current picture buffer can be reallocated before commencing the reconstruction of the following coded picture.

The video decoder (210) may perform decoding operations according to a predetermined video compression technology or a standard, such as ITU-T Rec. H.265. The coded video sequence may conform to a syntax specified by the video compression technology or standard being used, in the sense that the coded video sequence adheres to both the syntax of the video compression technology or standard and the profiles as documented in the video compression technology or standard. Specifically, a profile can select certain tools as the only tools available for use under that profile from all the tools available in the video compression technology or standard. Also necessary for compliance can be that the complexity of the coded video sequence is within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

In an aspect, the receiver (231) may receive additional (redundant) data with the encoded video. The additional data may be included as part of the coded video sequence(s). The additional data may be used by the video decoder (210) to properly decode the data and/or to more accurately reconstruct the original video data. Additional data can be in the form of, for example, temporal, spatial, or signal noise ratio (SNR) enhancement layers, redundant slices, redundant pictures, forward error correction codes, and so on.

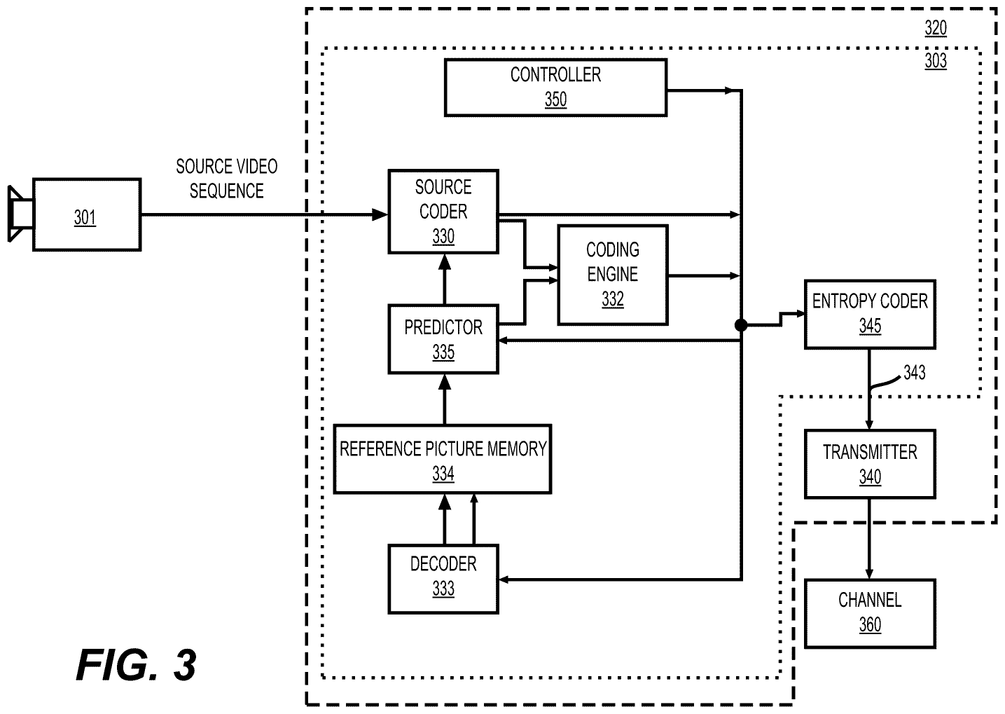

FIG. 3 shows an example of a block diagram of a video encoder (303). The video encoder (303) is included in an electronic device (320). The electronic device (320) includes a transmitter (340) (e.g., transmitting circuitry). The video encoder (303) can be used in the place of the video encoder (103) in the FIG. 1 example.

The video encoder (303) may receive video samples from a video source (301) (that is not part of the electronic device (320) in the FIG. 3 example) that may capture video image(s) to be coded by the video encoder (303). In another example, the video source (301) is a part of the electronic device (320).

The video source (301) may provide the source video sequence to be coded by the video encoder (303) in the form of a digital video sample stream that can be of any suitable bit depth (for example: 8 bit, 10 bit, 12 bit, . . . ), any colorspace (for example, BT.601 Y CrCB, RGB, . . . ), and any suitable sampling structure (for example Y CrCb 4:2:0, Y CrCb 4:4:4). In a media serving system, the video source (301) may be a storage device storing previously prepared video. In a videoconferencing system, the video source (301) may be a camera that captures local image information as a video sequence. Video data may be provided as a plurality of individual pictures that impart motion when viewed in sequence. The pictures themselves may be organized as a spatial array of pixels, wherein each pixel can comprise one or more samples depending on the sampling structure, color space, etc. in use. The description below focuses on samples.

According to an aspect, the video encoder (303) may code and compress the pictures of the source video sequence into a coded video sequence (343) in real time or under any other time constraints as required. Enforcing appropriate coding speed is one function of a controller (350). In some aspects, the controller (350) controls other functional units as described below and is functionally coupled to the other functional units. The coupling is not depicted for clarity. Parameters set by the controller (350) can include rate control related parameters (picture skip, quantizer, lambda value of rate-distortion optimization techniques, . . . ), picture size, group of pictures (GOP) layout, maximum motion vector search range, and so forth. The controller (350) can be configured to have other suitable functions that pertain to the video encoder (303) optimized for a certain system design.

In some aspects, the video encoder (303) is configured to operate in a coding loop. As an oversimplified description, in an example, the coding loop can include a source coder (330) (e.g., responsible for creating symbols, such as a symbol stream, based on an input picture to be coded, and a reference picture(s)), and a (local) decoder (333) embedded in the video encoder (303). The decoder (333) reconstructs the symbols to create the sample data in a similar manner as a (remote) decoder also would create. The reconstructed sample stream (sample data) is input to the reference picture memory (334). As the decoding of a symbol stream leads to bit-exact results independent of decoder location (local or remote), the content in the reference picture memory (334) is also bit exact between the local encoder and remote encoder. In other words, the prediction part of an encoder “sees” as reference picture samples exactly the same sample values as a decoder would “see” when using prediction during decoding. This fundamental principle of reference picture synchronicity (and resulting drift, if synchronicity cannot be maintained, for example because of channel errors) is used in some related arts as well.

The operation of the “local” decoder (333) can be the same as a “remote” decoder, such as the video decoder (210), which has already been described in detail above in conjunction with FIG. 2. Briefly referring also to FIG. 2, however, as symbols are available and encoding/decoding of symbols to a coded video sequence by an entropy coder (345) and the parser (220) can be lossless, the entropy decoding parts of the video decoder (210), including the buffer memory (215), and parser (220) may not be fully implemented in the local decoder (333).

In an aspect, a decoder technology except the parsing/entropy decoding that is present in a decoder is present, in an identical or a substantially identical functional form, in a corresponding encoder. Accordingly, the disclosed subject matter focuses on decoder operation. The description of encoder technologies can be abbreviated as they are the inverse of the comprehensively described decoder technologies. In certain areas a more detail description is provided below.

During operation, in some examples, the source coder (330) may perform motion compensated predictive coding, which codes an input picture predictively with reference to one or more previously coded picture from the video sequence that were designated as “reference pictures.” In this manner, the coding engine (332) codes differences between pixel blocks of an input picture and pixel blocks of reference picture(s) that may be selected as prediction reference(s) to the input picture.

The local video decoder (333) may decode coded video data of pictures that may be designated as reference pictures, based on symbols created by the source coder (330). Operations of the coding engine (332) may advantageously be lossy processes. When the coded video data may be decoded at a video decoder (not shown in FIG. 3), the reconstructed video sequence typically may be a replica of the source video sequence with some errors. The local video decoder (333) replicates decoding processes that may be performed by the video decoder on reference pictures and may cause reconstructed reference pictures to be stored in the reference picture memory (334). In this manner, the video encoder (303) may store copies of reconstructed reference pictures locally that have common content as the reconstructed reference pictures that will be obtained by a far-end video decoder (absent transmission errors).

The predictor (335) may perform prediction searches for the coding engine (332). That is, for a new picture to be coded, the predictor (335) may search the reference picture memory (334) for sample data (as candidate reference pixel blocks) or certain metadata such as reference picture motion vectors, block shapes, and so on, that may serve as an appropriate prediction reference for the new pictures. The predictor (335) may operate on a sample block-by-pixel block basis to find appropriate prediction references. In some cases, as determined by search results obtained by the predictor (335), an input picture may have prediction references drawn from multiple reference pictures stored in the reference picture memory (334).

The controller (350) may manage coding operations of the source coder (330), including, for example, setting of parameters and subgroup parameters used for encoding the video data.

Output of all aforementioned functional units may be subjected to entropy coding in the entropy coder (345). The entropy coder (345) translates the symbols as generated by the various functional units into a coded video sequence, by applying lossless compression to the symbols according to technologies such as Huffman coding, variable length coding, arithmetic coding, and so forth.

The transmitter (340) may buffer the coded video sequence(s) as created by the entropy coder (345) to prepare for transmission via a communication channel (360), which may be a hardware/software link to a storage device which would store the encoded video data. The transmitter (340) may merge coded video data from the video encoder (303) with other data to be transmitted, for example, coded audio data and/or ancillary data streams (sources not shown).

The controller (350) may manage operation of the video encoder (303). During coding, the controller (350) may assign to each coded picture a certain coded picture type, which may affect the coding techniques that may be applied to the respective picture. For example, pictures often may be assigned as one of the following picture types:

An Intra Picture (I picture) may be coded and decoded without using any other picture in the sequence as a source of prediction. Some video codecs allow for different types of intra pictures, including, for example Independent Decoder Refresh (“IDR”) Pictures.

A predictive picture (P picture) may be coded and decoded using intra prediction or inter prediction using a motion vector and reference index to predict the sample values of each block.

A bi-directionally predictive picture (B Picture) may be coded and decoded using intra prediction or inter prediction using two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded predictively, via spatial prediction or via temporal prediction with reference to one previously coded reference picture. Blocks of B pictures may be coded predictively, via spatial prediction or via temporal prediction with reference to one or two previously coded reference pictures.

The video encoder (303) may perform coding operations according to a predetermined video coding technology or standard, such as ITU-T Rec. H.265. In its operation, the video encoder (303) may perform various compression operations, including predictive coding operations that exploit temporal and spatial redundancies in the input video sequence. The coded video data, therefore, may conform to a syntax specified by the video coding technology or standard being used.

In an aspect, the transmitter (340) may transmit additional data with the encoded video. The source coder (330) may include such data as part of the coded video sequence. Additional data may comprise temporal/spatial/SNR enhancement layers, other forms of redundant data such as redundant pictures and slices, SEI messages, VUI parameter set fragments, and so on.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

In some aspects, a bi-prediction technique can be used in the inter-picture prediction. According to the bi-prediction technique, two reference pictures, such as a first reference picture and a second reference picture that are both prior in decoding order to the current picture in the video (but may be in the past and future, respectively, in display order) are used. A block in the current picture can be coded by a first motion vector that points to a first reference block in the first reference picture, and a second motion vector that points to a second reference block in the second reference picture. The block can be predicted by a combination of the first reference block and the second reference block.

Further, a merge mode technique can be used in the inter-picture prediction to improve coding efficiency.

According to some aspects of the disclosure, predictions, such as inter-picture predictions and intra-picture predictions, are performed in the unit of blocks. For example, according to the HEVC standard, a picture in a sequence of video pictures is partitioned into coding tree units (CTU) for compression, the CTUs in a picture have the same size, such as 64×64 pixels, 32×32 pixels, or 16×16 pixels. In general, a CTU includes three coding tree blocks (CTBs), which are one luma CTB and two chroma CTBs. Each CTU can be recursively quadtree split into one or multiple coding units (CUs). For example, a CTU of 64×64 pixels can be split into one CU of 64×64 pixels, or 4 CUs of 32×32 pixels, or 16 CUs of 16×16 pixels. In an example, each CU is analyzed to determine a prediction type for the CU, such as an inter prediction type or an intra prediction type. The CU is split into one or more prediction units (PUs) depending on the temporal and/or spatial predictability. Generally, each PU includes a luma prediction block (PB), and two chroma PBs. In an aspect, a prediction operation in coding (encoding/decoding) is performed in the unit of a prediction block. Using a luma prediction block as an example of a prediction block, the prediction block includes a matrix of values (e.g., luma values) for pixels, such as 8×8 pixels, 16×16 pixels, 8×16 pixels, 16×8 pixels, and the like.

It is noted that the video encoders (103) and (303), and the video decoders (110) and (210) can be implemented using any suitable technique. In an aspect, the video encoders (103) and (303) and the video decoders (110) and (210) can be implemented using one or more integrated circuits. In another aspect, the video encoders (103) and (303), and the video decoders (110) and (210) can be implemented using one or more processors that execute software instructions.

Some aspects of the present disclosure provide techniques of using different clipping ranges in different parts of codec during the clipping processes in video and image processing to improve compression efficiency and coding flexibility. The techniques in the present disclosure may be used separately or combined in any order. Further, each of the techniques may be implemented by processing circuitry (e.g., one or more processors or one or more integrated circuits). In one example, the one or more processors execute a program that is stored in a non-transitory computer-readable medium.

The techniques can be implemented in various video coding standards, such as H264, H265, H266 (VVC), AV 1, AVS, and the like.

In some embodiments, the use of an adaptive clipping range, instead of a fixed clipping range dependent only on internal (codec) bit depth, improves the compression efficiency of the video codec. A bit-depth based clipping can be applied to multiple operations in the codec to avoid data overflow, such as in filtering, sampling, interpolation, weighted prediction, weighted combination, reconstruction, and other stages, to ensure that the generated prediction and reconstruction samples remain in a defined dynamic range.

Clipping operations can be used in various parts of video and image codecs. Generally, a clipping operation can be performed according to a parameter that is referred to a clipping range. The clipping range of a clipping process (also referred to a clipping operation) determines a minimal value and a maximal value of samples after the clipping process. For example, a clipping range (x, y) is inclusive of the upper and lower bounds, or the minimal value x and the maximal value y of the clipping range.

In some examples, a fixed clipping range can be used according to an internal bit-depth of a codec. The bit-depth based clipping can be applied to multiple operations in the codec to avoid data overflow, such as in filtering, sampling, interpolation, weighted prediction, weighted combination, reconstruction, and other stages, to ensure that the generated prediction and reconstruction samples remain in a defined dynamic range.

In an example, when an internal bit depth of a codec is set to 8 bits, each sample of the subject signal can be clipped in a clipping range of (0, 255). In an example, the clipping process for a sample z can be represented by Eq. (1):

$$Clip ( 0 , 255 , z ) = \{ \begin{matrix}0 , for z < 0 \\ 255 , for z > 0 \\ z , otherwise\end{matrix} \qquad Eq . ( 1 )$$

Similarly, in an example, when an internal bit depth is set to 10 bits, the clipping process for each sample z throughout the coding/decoding process can be represented by Eq. (2):

$$Clip ( 0 , 1023 , z ) = \{ \begin{matrix}0 , z < 0 \\ 1023 , z > 1023 \\ z , otherwise\end{matrix} \qquad Eq . ( 2 )$$

In some aspects, a general form of a clipping process with a clipping range (x, y) can be represented by Eq. (3):

$$Clip ( x , y , z ) = \{ \begin{matrix}x , z < x \\ y , z > y \\ z , otherwise\end{matrix} \qquad Eq . ( 3 )$$

In some aspects, a clipping process with an internal (codec) bit depth BitDepth can be represented by Eq. (4):

$$Clip G ( z ) = Clip ( 0 , ( 1 ≪ BitDepth ) - 1 , z ) \qquad Eq . ( 4 )$$

In some embodiments, an adaptive clipping range is used instead of a fixed clipping range dependent only on internal (codec) bit depth, the adaptive clipping range can improve the compression efficiency of the video codec. In some examples, a clipping range can be signaled in the coded video bitstream, and the clipping range can be applied at specific steps within reconstruction process.

Some aspects of the present disclosure provide techniques to further improve signaling and utilization of clipping range(s). For example, an encoder can determine at least a clipping range to apply during an encoding of one or more pictures by a video codec, the clipping range is different from a fixed clipping range that is based on a bitdepth of the video codec. The clipping range can be applied to sample values of the one or more pictures to generate clipped sample values. Th encoder can generate coded information in a bitstream based on the clipped sample values; and can determine an inclusion/exclusion of a syntax element indicative of the clipping range in the bitstream based on a codec configuration of the video codec. At the decoder side, the decoder can determine at least a clipping range according to one or more syntax elements in the coded video bitstream, the clipping range is different from a fixed clipping range that is based on a bitdepth of a video codec for encoding/decoding the coded information. The decoder can determine a configuration of a coding tool in the video codec based on the clipping range, and reconstruct the one or more pictures based on the video codec with the coding tool configured according to the configuration.

It is noted that clipping range or clipping ranges are used in the present disclosure without loss of generality. The clipping ranges in the present disclosure can refer to the clipping ranges of any color component, such as Y, Cb or Cr. It noted that the techniques described in the present disclosure can be applied to each, all, or any combination of the signal color components, such as Y, Cb, Cr, R, G, B, and the like.

In some aspects, a clipping range is used at the encoder side and is not signalled in the bitstream. In some examples, the clipping range is determined at the encoder side and is applied at a pre-filtering stage by clipping the filter output signal. The clipped filter output signal is then encoded into a bitstream. This clipping range is not signalled in the bitstream and is not used at the decoder side. In some examples, the pre-filtering stage is a first stage in video encoding, and is performed before the actual encoding. In some examples, the pre-filtering stage is before the video encoding. In an example, a denoise filer (e.g., a weak denoise filter) is used as a first stage in encoding, the filtering output from the denoise filter is clipped according to the clipping range, and the clipped signal is encoded into a bitstream. The clipping range is not included into the bitstream in an example.

In some examples, the clipping range is applied on the sample values that are final values from a processing stage of the video codec to generate the clipped sample values and interim values within the processing stage are not clipped at all. For example, the clipping range is applied to the output from the prefiltering stage, and no clipping is applied to any interim values within the prefiltering stage.

In some aspects, the clipping range(s) can be included into the bitstream, and the number of clipping ranges that are signalled in the bitstream can vary depending on the codec configuration. For example, the encoder can determine a number of clipping ranges to signal based on the coded configuration, and then signal the number of clipping ranges in the bitstream.

In some examples, the number of clipping ranges signalled in the bitstream is determined by a set of specific coding tools that are used in the compression/decompression process. In an example, for each specific coding tool, a number of clipping ranges may be to assist the specific coding tool.

In some examples, when the pre-filtering stage (before actual encoding) is used, while a clipping range is used in a clipping operation after the pre-filtering stage at the encoder side, two clipping ranges can be signalled in the bitstream to represent signal dynamic ranges before and after the pre-filtering stage. The two clipping ranges can be used to assist specific coding tools in the reconstruction process respectively.

For example, the two clipping ranges includes a first clipping range that represents a “before pre-filter” range (e.g., a dynamic range before the pre-filtering stage) for signals input to the prefiltering stage, and a second clipping range that represents an “after pre-filter” range (e.g., a dynamic range after the pre-filtering stage) for signals output from the pre-filtering stage. In an example, the first clipping range can be used during the in-loop filtering process. For example, the in-loop filtering processing includes a Wiener loop filter that is configured to minimize an error signal between the estimated signal (e.g., reconstructed signal) and the desired signal. In an example, the filter parameters of the Wiener loop filter can be efficiently determined based on the first clipping range which represents the “before pre-filter” range. In another example, the second range which represents the “after pre-filter” range is used during the motion compensation process. For example, one or more motion compensation tools can be configured based on the second range for efficient processing.

In some aspects, the applicability of clipping range(s) utilization is (are) limited for specific coding stages.

In some examples, when the dynamic range of the subject (to be compressed) signal is modified by a function (e.g., a linear function or a non-linear function) during compression/decompression process, the corresponding clipping range(s) is (are) not modified accordingly by the function, but used directly as they were derived in a clipping operation on the subject signal.

For example, mapping (also referred to as reshaping) techniques are used in video coding to modify dynamic ranges of the subject signals. The mapping techniques can be used to achieve better exploiting the samples codewords values distribution of the pictures in a video. The mapping techniques can use functions (also referred to as mapping functions) to change value domains of samples.

The mapping and inverse mapping can be out of a decoding loop. For example, the mapping process can be applied to the input samples of the encoder, prior to the core encoding; and the inverse mapping process can be applied at decoder side to the output samples from the decoder.

The mapping and inverse mapping can also be in the decoding loop. In some examples, a technique that is referred to as luma mapping with chroma scaling (LMCS) is used for an in-loop reshaping. The mapping (a.k.a. reshaping) of the luma or chroma signal is achieved internally to the coding loop.

In some examples of LMCS, at the encoder, the residual signal before quantization is generated after applying the mapping function respectively to the original sample (to be coded) and the prediction sample. For example, the mapping function is applied to the original sample to generate a mapped original sample, the mapping function is also applied to the prediction sample to generate a mapped prediction sample, the residual signal is calculated as a difference of the mapped original sample and the mapped prediction sample. The residuals of a block can be transformed into transform coefficients, and the transform coefficients can be quantized. At the decoder, the residuals can be calculated by dequantization and inverse transform. Further, the mapping function is applied to the prediction sample to generate mapped prediction sample, then mapped prediction sample is combined with a residual signal to form mapped reconstruction sample. Further, the inverse mapping function is applied to the mapped reconstruction sample to generate the reconstruction sample.

In some examples, when mapping and inverse mapping are used, the clipping range is not modified according to the mapping. For example, the clipping range derived from the bitstream is used in the clipping operation without being modified by the mapping.

In some examples, when the dynamic range of the subject (to be compressed) signal is modified by a function (e.g., a linear function or a non-linear function) during the compression/decompression process, the corresponding clipping range(s) is (are) NOT modified accordingly by the function, and a default clipping range is used in a clipping operation that is applied on the subject signal.

In some aspects, signaling of a clipping range(s) for a subject signal can utilize the subject signal information (e.g., content features).

In some examples, for the compression configurations where the input signal dynamic range is less that the codec internal dynamic range, the clipping range is signalled in the original (smaller) dynamic range. In an example, when the content to be compressed/decompressed has 8 bits dynamic range and the codec operates with the 10 bits internal dynamic range, the clipping range that is signalled in the bitstream is scaled down to 8 bits dynamic range. In some examples, the internal dynamic range is 10 bits, a subject signal, such as the output signal from the encoder which is the input signal to the decoder, is suitably scaled down to the 8 bits dynamic range, thus the subject signal can be encoded using 8 bits to reduce signaling cost. At the decoder side, the decoder can suitably scale up the subject signal to 10 bits dynamic range to achieve higher calculation precision. In some examples, to include a clipping range for clipping 10 bits content within codec for compression/decompression, the clipping range is scaled down to 8 bits and then included in the bitstream. At the decoder side, the decoder can scale up the clipping range to 10 bits. For example, at the encoder side, a clipping range of (40,1000) for a clipping operation on an internal signal of the video codec can be scaled down to (10, 250) to be included in the bitstream. At the decoder side, the decoder decodes a clipping range of (10,250) from the bitstream, and since the internal dynamic range is 10 bits, the (10, 250) is scaled up to (40, 1000) and applied in the decoder.

In some examples, the clipping range(s) signalling is performed based on the sign value that can be determined by decoder. In an example, when the signalling range is determined by offsetting some predefined values that represent minimal and maximal possible values, the offset values are signalled in the bitstream as unsinged values. At the decoder side, the decoder can determine the appropriate signs for the offsets.

In an example, the contents are of 8 bits, and a clipping range to be signalled is (10, 240). In the example, a predefined range is (0, 255), and two offsets can be applied to the predefined range to signal the clipping range. For example, two unsigned values (10, 15) are signalled in the bitstream. At the decoder side, the decoder can apply a positive sign to a first unsigned value indicating the offset to the minimal of the clipping range. For example, +10 is applied to 0 in the example. The decoder can also apply a negative sign to the second unsigned value indicating the offset to the maximal of the clipping range. For example, −15 is applied to 255 in the example. Thus, the decoder can derive the clipping range to be (10, 240).

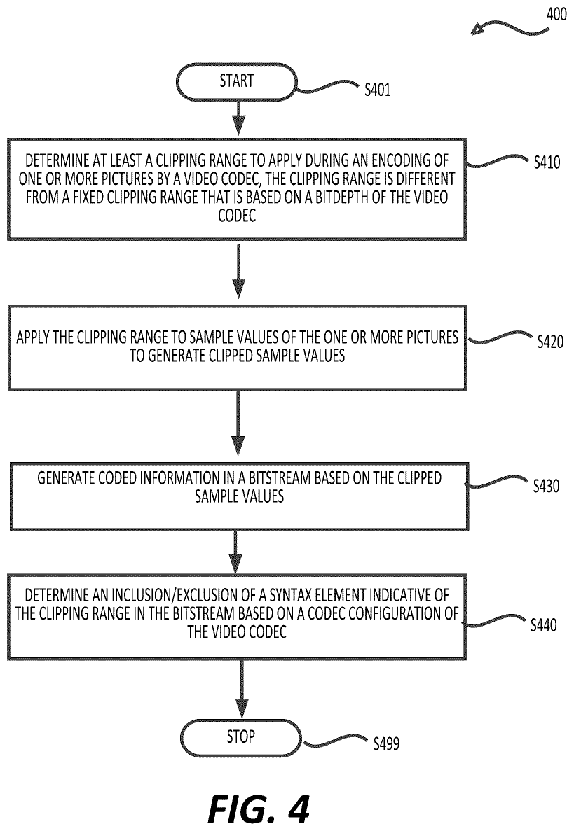

FIG. 4 shows a flow chart outlining a process (400) according to an aspect of the disclosure. The process (400) can be used in a video encoder. In various aspects, the process (400) is executed by processing circuitry, such as the processing circuitry that performs functions of the video encoder (103), the processing circuitry that performs functions of the video encoder (303), and the like. In some aspects, the process (400) is implemented in software instructions, thus when the processing circuitry executes the software instructions, the processing circuitry performs the process (400). The process starts at (S401) and proceeds to (S410).

At (S410), at least a clipping range to apply during an encoding of one or more pictures by a video codec is determined, the clipping range is different from a fixed clipping range that is based on a bitdepth of the video codec.

At (S420), the clipping range is applied to sample values of the one or more pictures to generate clipped sample values.

At (S430), coded information in a bitstream is generated based on the clipped sample values.

At (S440), an inclusion/exclusion of a syntax element indicative of the clipping range in the bitstream is determined based on a codec configuration of the video codec.

In some aspects, the clipping range is applied on the sample values that are output from a pre-filtering stage of the video codec to generate the clipped sample values. The clipped sample values are provided as inputs for the encoding by the video codec, the clipping range is excluded from the bitstream when a reconstruction by the video codec has no reliance on the clipping range in an example.

In some aspects, whether one or more coding tools of the video codec uses information of the clipping range is determined, the syntax element indicative of the clipping range is included in the bitstream when the information of the clipping range is used by the one or more coding tools of the video codec.

In some aspects, a plurality of clipping ranges are determined to apply during the encoding by the video codec. One or more clipping ranges are selected from the plurality of clipping ranges based on the codec configuration of the video codec, the one or more clipping ranges are respectively used by one or more tools of the video codec. Thus, one or more syntax elements indicative of the one or more clipping ranges are included in the bitstream.

In some examples, a first clipping range and a second clipping range to apply during the encoding by the video codec are determined, the first clipping range is applied to input values of a prefiltering stage of the video codec and the second clipping range is applied to output values of the prefiltering stage of the video codec, the output values that are clipped in the second clipping range are encoded into the bitstream. The first clipping range and the second clipping range are determined to be used respectively in a reconstruction by the video codec. One or more syntax elements indicative of the first clipping range and the second clipping range are included into the bitstream.

In an example, an in-loop filter for the reconstruction in the video codec is determined to use information of the first clipping range, for example for configuring the in-loop filter. In another example, a motion compensation tool of the video codec is determined to use information of the second clipping range, for example for configuring the motion compensation tool.

In some examples, a subject signal (e.g., input to a stage in the video codec, output from a stage in the video codec, and the like) for applying a clipping operation has a dynamic range that is modified based on a function. In an example, the clipping operation with the clipping range is applied on the subject signal without a modification of the clipping range according to the function. In another example, the clipping operation with a default clipping range is applied on the subject signal. In another example, the clipping operation with a modified clipping range is applied on the subject signal. In some examples, the function can be a linear function. In some examples, the function can be a non-linear function.

In some aspects, the video codec is determined to use an internal dynamic range corresponding to a first bitdepth that is higher than a second bitdepth used by input signals of the video codec. A clipping range to be applied to an internal signal of the video codec is scaled down to a scaled clipping range having the second bitdepth. The scaled clipping range having the second bitdepth is included into the bitstream. In an example, the internal dynamic range of the video codec has 10-bitdepth, input signal to the video codec for compression/decompression has a dynamic range of 8-bitdepth. Then, a clipping range to be applied to an internal signal can be scaled from 10-bitdepth to 8-bitdepth, and the scaled clipping range is included into the bitstream.

In some examples, at least an unsigned value is included in the bitstream, the unsigned value indicates an offset of a clipping range with regard to a predefined clipping range. The offset can be applied to one of a minimal value and a maximal value of the predefined clipping range.

In some examples, the clipping range is applied on the sample values that are final values from a processing stage of the video codec to generate the clipped sample values and interim values within the processing stage are not clipped at all. For example, the clipping range is applied to the output from the prefiltering stage, and no clipping is applied to interim values within the prefiltering stage.

Then, the process proceeds to (S499) and terminates.

The process (400) can be suitably adapted. Step(s) in the process (400) can be modified and/or omitted. Additional step(s) can be added. Any suitable order of implementation can be used.

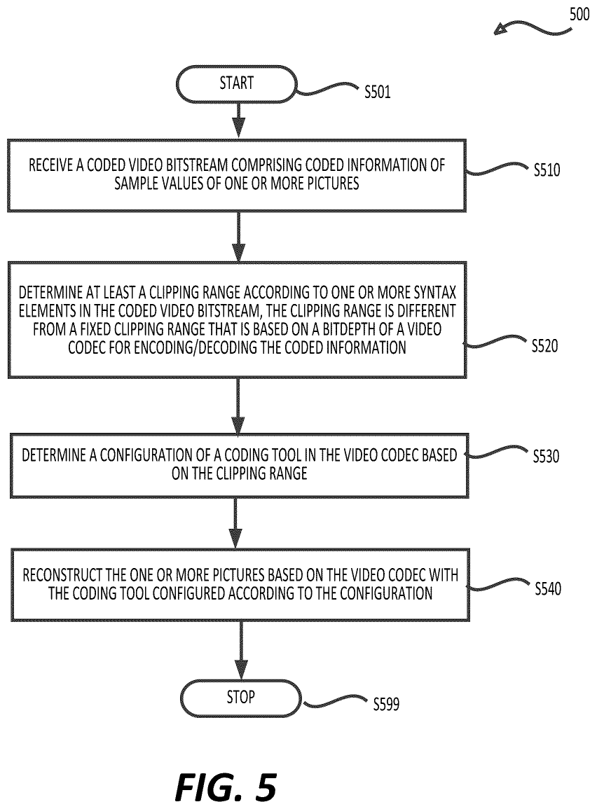

FIG. 5 shows a flow chart outlining a process (500) according to an aspect of the disclosure. The process (500) can be used in a video decoder. In various aspects, the process (500) is executed by processing circuitry, such as the processing circuitry that performs functions of the video decoder (110), the processing circuitry that performs functions of the video decoder (210), and the like. In some aspects, the process (500) is implemented in software instructions, thus when the processing circuitry executes the software instructions, the processing circuitry performs the process (500). The process starts at (S501) and proceeds to (S510).

At (S510), a coded video bitstream is received. The coded video bitstream includes coded information of sample values of one or more pictures.

At (S520), at least a clipping range is determined according to one or more syntax elements in the coded video bitstream, the clipping range is different from a fixed clipping range that is based on a bitdepth of a video codec for encoding/decoding the coded information.

At (S530), a configuration of a coding tool in the video codec is determined based on the clipping range.

At (S540), the one or more pictures are reconstructed based on the video codec with the coding tool configured according to the configuration.

In some aspects, the clipping range is applied to input values of a prefiltering stage during an encoding of the sample values. A configuration of an in-loop filter for reconstruction in the video codec is determined based on information of the clipping range.

In some aspects, the clipping range is applied to output values of a prefiltering stage during an encoding of the sample values. A configuration of a motion compensation tool of the video codec is determined based on information of the clipping range.

In some examples, a subject signal to be applied by a clipping operation has a dynamic range that is modified by a function. In an example, the clipping operation with the clipping range is applied on the subject signal without a modification of the clipping range according to the function. In another example, the clipping operation with a default clipping range (e.g., a default clipping range based on a bitdepth) is applied on the subject signal. In another example, the clipping operation with a modified clipping range (e.g., modified according to the function) is applied on the subject signal.

It is noted the function can be a linear function or can be a non-linear function.

In some aspects, the video codec uses an internal dynamic range corresponding to a first bitdepth that is higher than a second bitdepth used by input signals of the video codec. In some examples, the clipping range obtained from the coded video bitstream is based on the second bitdepth, and the chipping range can be scaled up to obtain a scaled clipping range having the first bitdepth. A clipping operation with the scaled clipping range can be applied on an internal signal of the video codec.

In some aspects, the clipping range can be signaled as unsigned value(s), and the sign can be suitably determined at the decoder side. In some examples, at least an unsigned value is determined according to the one or more syntax elements in the coded video bitstream. A sign for the unsigned value can be determined. The clipping range can be determined based on the unsigned value and the sign.

In an example, a first unsigned value and a second unsigned value are determined according to the one or more syntax elements in the coded video bitstream. A first offset is determined as a combination of a positive sign with the first unsigned value. The first offset is applied to a minimal value of a predefined range (e.g., based on bitdepth) to calculate a minimal value of the clipping range. A second offset is determined as a combination of a negative sign with the second unsigned value. The second offset is applied on a maximal value of the predefined range to calculate a maximum value of the clipping range.

In some examples, the clipping range is applied on the sample values that are final values from a processing stage of the video codec to generate the clipped sample values and interim values within the processing stage are not clipped at all. For example, the clipping range is applied to the output from a post-filtering stage, and no clipping is applied to interim values within the post-filtering stage.

Then, the process proceeds to (S599) and terminates.

The process (500) can be suitably adapted. Step(s) in the process (500) can be modified and/or omitted. Additional step(s) can be added. Any suitable order of implementation can be used.

According to an aspect of the disclosure, a method of processing visual media data is provided. In the method, a conversion between a visual media file and a bitstream of visual media data is performed according to a format rule. For example, the bitstream may be a bitstream that is decoded/encoded in any of the decoding and/or encoding methods described herein. The format rule may specify one or more constraints of the bitstream and/or one or more processes to be performed by the decoder and/or encoder.

In an example, the bitstream includes coded information of sample values of one or more pictures. The format rule specifies that at least a clipping range is determined according to one or more syntax elements in the coded video bitstream, the clipping range is different from a fixed clipping range that is based on a bitdepth of a video codec for processing the sample values of the one or more pictures. The format rule also specifies that a configuration of a coding tool in the video codec is determined based on the clipping range, and the one or more pictures are reconstructed based on the video codec with the coding tool configured according to the configuration.

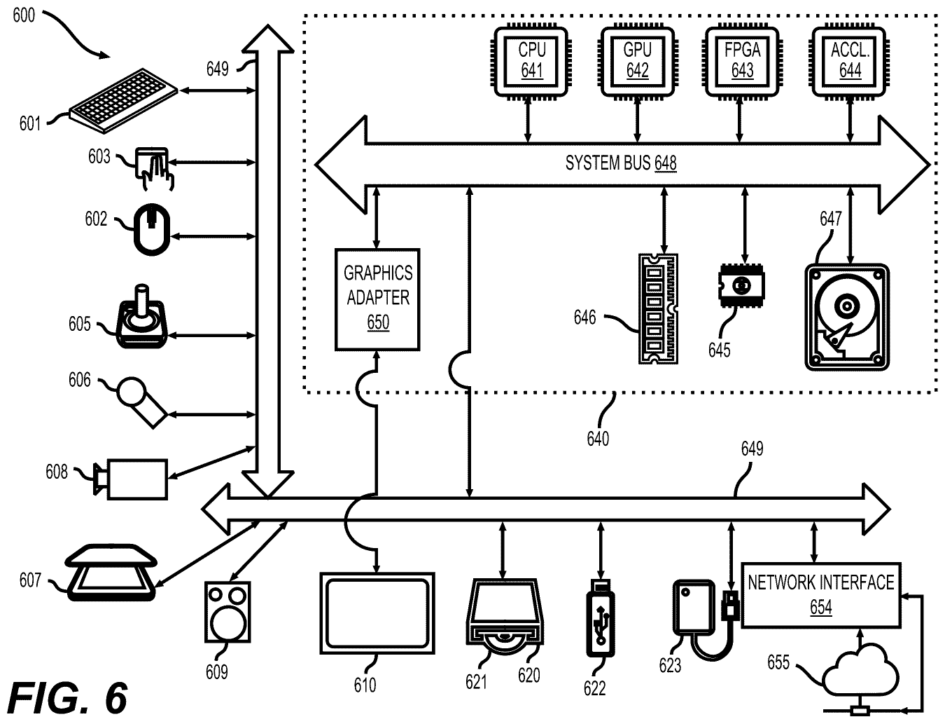

The techniques described above, can be implemented as computer software using computer-readable instructions and physically stored in one or more computer-readable media. For example, FIG. 6 shows a computer system (600) suitable for implementing certain aspects of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 6 for computer system (600) are examples and are not intended to suggest any limitation as to the scope of use or functionality of the computer software implementing aspects of the present disclosure. Neither should the configuration of components be interpreted as having any dependency or requirement relating to any one or combination of components illustrated in the example aspect of computer system (600).

Computer system (600) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (601), mouse (602), trackpad (603), touch screen (610), data-glove (not shown), joystick (605), microphone (606), scanner (607), camera (608).

Computer system (600) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (610), data-glove (not shown), or joystick (605), but there can also be tactile feedback devices that do not serve as input devices), audio output devices (such as: speakers (609), headphones (not depicted)), visual output devices (such as screens (610) to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted).

Computer system (600) can also include human accessible storage devices and their associated media such as optical media including CD/DVD ROM/RW (620) with CD/DVD or the like media (621), thumb-drive (622), removable hard drive or solid state drive (623), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (600) can also include an interface (654) to one or more communication networks (655). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (649) (such as, for example USB ports of the computer system (600)); others are commonly integrated into the core of the computer system (600) by attachment to a system bus as described below (for example Ethernet interface into a PC computer system or cellular network interface into a smartphone computer system). Using any of these networks, computer system (600) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (640) of the computer system (600).

The core (640) can include one or more Central Processing Units (CPU) (641), Graphics Processing Units (GPU) (642), specialized programmable processing units in the form of Field Programmable Gate Areas (FPGA) (643), hardware accelerators for certain tasks (644), graphics adapters (650), and so forth. These devices, along with Read-only memory (ROM) (645), Random-access memory (646), internal mass storage such as internal non-user accessible hard drives, SSDs, and the like (647), may be connected through a system bus (648). In some computer systems, the system bus (648) can be accessible in the form of one or more physical plugs to enable extensions by additional CPUs, GPU, and the like. The peripheral devices can be attached either directly to the core's system bus (648), or through a peripheral bus (649). In an example, the screen (610) can be connected to the graphics adapter (650). Architectures for a peripheral bus include PCI, USB, and the like.

CPUs (641), GPUs (642), FPGAs (643), and accelerators (644) can execute certain instructions that, in combination, can make up the aforementioned computer code. That computer code can be stored in ROM (645) or RAM (646). Transitional data can also be stored in RAM (646), whereas permanent data can be stored for example, in the internal mass storage (647). Fast storage and retrieve to any of the memory devices can be enabled through the use of cache memory, that can be closely associated with one or more CPU (641), GPU (642), mass storage (647), ROM (645), RAM (646), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture (600), and specifically the core (640) can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core (640) that are of non-transitory nature, such as core-internal mass storage (647) or ROM (645). The software implementing various aspects of the present disclosure can be stored in such devices and executed by core (640). A computer-readable medium can include one or more memory devices or chips, according to particular needs. The software can cause the core (640) and specifically the processors therein (including CPU, GPU, FPGA, and the like) to execute particular processes or particular parts of particular processes described herein, including defining data structures stored in RAM (646) and modifying such data structures according to the processes defined by the software. In addition or as an alternative, the computer system can provide functionality as a result of logic hardwired or otherwise embodied in a circuit (for example: accelerator (644)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

While this disclosure has described several examples of aspects, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

The above disclosure also encompasses the features noted below. The features may be combined in various manners and are not limited to the combinations noted below.

(1). A method of video encoding, including: determining at least a clipping range to apply during an encoding of one or more pictures by a video codec, the clipping range being different from a fixed clipping range that is based on a bitdepth of the video codec; applying the clipping range to sample values of the one or more pictures to generate clipped sample values; generating coded information in a bitstream based on the clipped sample values; and determining an inclusion/exclusion of a syntax element indicative of the clipping range in the bitstream based on a codec configuration of the video codec.

(2). The method of feature (1), in which the applying includes: applying the clipping range on the sample values that are output from a pre-filtering stage of the video codec to generate the clipped sample values; and providing the clipped sample values as inputs for the encoding by the video codec, the clipping range being excluded from the bitstream when a reconstruction by the video codec has no reliance on the clipping range.

(3). The method of any of features (1) to (2), also including: determining whether one or more coding tools of the video codec uses information of the clipping range; and including the syntax element indicative of the clipping range in the bitstream when the information of the clipping range is used by the one or more coding tools of the video codec.

(4). The method of any of features (1) to (3), also including: determining a plurality of clipping ranges to apply during the encoding by the video codec; selecting one or more clipping ranges from the plurality of clipping ranges based on the codec configuration of the video codec, the one or more clipping ranges being respectively used by one or more tools of the video codec; and including one or more syntax elements indicative of the one or more clipping ranges in the bitstream.

(5). The method of any of features (1) to (4), further including: determining a first clipping range and a second clipping range to apply during the encoding by the video codec, the first clipping range being applied to input values of a prefiltering stage of the video codec and the second clipping range being applied to output values of the prefiltering stage of the video codec, the output values that are clipped in the second clipping range being encoded into the bitstream; determining that the first clipping range and the second clipping range are used respectively in a reconstruction by the video codec; and including one or more syntax elements indicative of the first clipping range and the second clipping range into the bitstream.

(6). The method of any of features (1) to (5), in which the determining that the first clipping range and the second clipping range are used respectively in the reconstruction includes: determining that an in-loop filter for the reconstruction in the video codec uses information of the first clipping range that is applied to the input values of the prefiltering stage of the video codec.

(7). The method of any of features (1) to (6), in which the determining that the first clipping range and the second clipping range are used respectively in the reconstruction includes: determining that a motion compensation tool of the video codec uses information of the second clipping range that is applied to the output values of the prefiltering stage of the video codec.

(8). The method of any of features (1) to (7), in which a subject signal for applying a clipping operation has a dynamic range that is modified based on a function, and the method includes at least one of: applying the clipping operation with the clipping range on the subject signal without a modification of the clipping range according to the function; applying the clipping operation with a default clipping range on the subject signal; or applying the clipping operation with a modified clipping range on the subject signal.

(9). The method of any of features (1) to (8), in which the function includes at least one of a linear function and a non-linear function.

(10). The method of any of features (1) to (9), further including: determining that the video codec uses an internal dynamic range corresponding to a first bitdepth that is higher than a second bitdepth used by input signals of the video codec; scaling down a clipping range to be applied to an internal signal of the video codec to a scaled clipping range having the second bitdepth; and including the scaled clipping range having the second bitdepth into the bitstream.

(11). The method of any of features (1) to (10), further including: including at least an unsigned value in the bitstream to indicate the clipping range, the unsigned value indicating an offset to one of a minimal value and a maximal value of a predefined clipping range.

(12). The method of any of features (1) to (11), in which: the applying includes applying the clipping range on the sample values that are final values from a processing stage of the video codec to generate the clipped sample values, interim values within the processing stage not being clipped.

(13). A method of video decoding, including: receiving a coded video bitstream comprising coded information of sample values of one or more pictures; determining at least a clipping range according to one or more syntax elements in the coded video bitstream, the clipping range being different from a fixed clipping range that is based on a bitdepth of a video codec for encoding/decoding the coded information; determining a configuration of a coding tool in the video codec based on the clipping range; and reconstructing the one or more pictures based on the video codec with the coding tool configured according to the configuration.

(14). The method of feature (13), in which the clipping range is applied to input values of a prefiltering stage during an encoding of the sample values, the determining the configuration of the coding tool includes: determining a configuration of an in-loop filter for reconstruction in the video codec based on information of the clipping range.

(15). The method of any of features (13) to (14), in which the clipping range is applied to output values of a prefiltering stage during an encoding of the sample values, the determining the configuration of the coding tool includes: determining a configuration of a motion compensation tool of the video codec based on information of the clipping range.

(16). The method of any of features (13) to (15), in which a subject signal to be applied by a clipping operation has a dynamic range that is modified by a function, and the method comprises at least one of: applying the clipping operation with the clipping range on the subject signal without a modification of the clipping range according to the function; applying the clipping operation with a default clipping range on the subject signal; or applying the clipping operation with a modified clipping range on the subject signal.

(17). The method of any of features (13) to (16), in which the function includes at least one of a linear function and a non-linear function.

(18). The method of any of features (13) to (17), in which the video codec uses an internal dynamic range corresponding to a first bitdepth that is higher than a second bitdepth used by input signals of the video codec, and the method includes scaling up the clipping range to obtain a scaled clipping range having the first bitdepth; and applying a clipping operation with the scaled clipping range on an internal signal of the video codec.

(19). The method of any of features (13) to (18), in which the determining the clipping range includes: determining at least an unsigned value according to the one or more syntax elements in the coded video bitstream; determining a sign for the unsigned value; and determining the clipping range based on the unsigned value and the sign.

(20). The method of any of features (13) to (19), in which the determining the clipping range includes: determining a first unsigned value and a second unsigned value according to the one or more syntax elements in the coded video bitstream; determining to apply a first offset that is a combination of a positive sign with the first unsigned value to a minimal value of a predefined range to calculate a minimal value of the clipping range; and determining to apply a second offset that is a combination of a negative sign with the second unsigned value to a maximal value of the predefined range to calculate a maximum value of the clipping range.

(21). The method of any of features (13) to (20), further including: applying the clipping range on final values from a processing stage of the video codec, interim values within the processing stage not being clipped.

(22). A method of processing visual media data, the method including processing a bitstream of visual media data according to a format rule, in which: the bitstream includes coded information of sample values of one or more pictures; and the format rule specifies that: at least a clipping range is determined according to one or more syntax elements in the coded video bitstream, the clipping range being different from a fixed clipping range that is based on a bitdepth of a video codec for processing the sample values of the one or more pictures; a configuration of a coding tool in the video codec is determined based on the clipping range; and the one or more pictures are reconstructed based on the video codec with the coding tool configured according to the configuration.

(23). An apparatus for video encoding, including processing circuitry that is configured to perform the method of any of features (1) to (12).

(24). An apparatus for video decoding, including processing circuitry that is configured to perform the method of any of features (13) to (21).

(25). A non-transitory computer-readable storage medium storing instructions which when executed by at least one processor cause the at least one processor to perform the method of any of features (1) to (22).

What is claimed is:

1. A method of video encoding, comprising:
determining at least a clipping range to apply during an encoding of one or more pictures by a video codec, the clipping range being different from a fixed clipping range that is based on a bitdepth of the video codec;
applying the clipping range to sample values of the one or more pictures to generate clipped sample values;
generating coded information in a bitstream based on the clipped sample values; and
determining an inclusion/exclusion of a syntax element indicative of the clipping range in the bitstream based on a codec configuration of the video codec.

2. The method of claim 1, wherein:
the applying comprises:
applying the clipping range on the sample values that are output from a pre-filtering stage of the video codec to generate the clipped sample values; and
providing the clipped sample values as inputs for the encoding by the video codec, the clipping range being excluded from the bitstream when a reconstruction by the video codec has no reliance on the clipping range.

3. The method of claim 1, further comprising:
determining whether one or more coding tools of the video codec uses information of the clipping range; and
including the syntax element indicative of the clipping range in the bitstream when the information of the clipping range is used by the one or more coding tools of the video codec.

4. The method of claim 1, further comprising:
determining a plurality of clipping ranges to apply during the encoding by the video codec;
selecting one or more clipping ranges from the plurality of clipping ranges based on the codec configuration of the video codec, the one or more clipping ranges being respectively used by one or more tools of the video codec; and
including one or more syntax elements indicative of the one or more clipping ranges in the bitstream.

5. The method of claim 4, further comprising:
determining a first clipping range and a second clipping range to apply during the encoding by the video codec, the first clipping range being applied to input values of a prefiltering stage of the video codec and the second clipping range being applied to output values of the prefiltering stage of the video codec, the output values that are clipped in the second clipping range being encoded into the bitstream;
determining that the first clipping range and the second clipping range are used respectively in a reconstruction by the video codec; and
including one or more syntax elements indicative of the first clipping range and the second clipping range into the bitstream.

6. The method of claim 5, wherein the determining that the first clipping range and the second clipping range are used respectively in the reconstruction comprises:
determining that an in-loop filter for the reconstruction in the video codec uses information of the first clipping range that is applied to the input values of the prefiltering stage of the video codec.

7. The method of claim 5, wherein the determining that the first clipping range and the second clipping range are used respectively in the reconstruction comprises:
determining that a motion compensation tool of the video codec uses information of the second clipping range that is applied to the output values of the prefiltering stage of the video codec.

8. The method of claim 1, wherein a subject signal for applying a clipping operation has a dynamic range that is modified based on a function, and the method comprises at least one of:
applying the clipping operation with the clipping range on the subject signal without a modification of the clipping range according to the function;
applying the clipping operation with a default clipping range on the subject signal; or
applying the clipping operation with a modified clipping range on the subject signal.

9. The method of claim 8, wherein the function includes at least one of a linear function and a non-linear function.

10. The method of claim 1, further comprising:
determining that the video codec uses an internal dynamic range corresponding to a first bitdepth that is higher than a second bitdepth used by input signals of the video codec;
scaling down a clipping range to be applied to an internal signal of the video codec to a scaled clipping range having the second bitdepth; and
including the scaled clipping range having the second bitdepth into the bitstream.

11. The method of claim 1, further comprising:
including at least an unsigned value in the bitstream to indicate the clipping range, the unsigned value indicating an offset to one of a minimal value and a maximal value of a predefined clipping range.

12. The method of claim 1, wherein:
the applying comprises:
applying the clipping range on the sample values that are final values from a processing stage of the video codec to generate the clipped sample values, interim values within the processing stage not being clipped.

13. A method of video decoding, comprising:
receiving a coded video bitstream comprising coded information of sample values of one or more pictures;
determining at least a clipping range according to one or more syntax elements in the coded video bitstream, the clipping range being different from a fixed clipping range that is based on a bitdepth of a video codec for encoding/decoding the coded information;
determining a configuration of a coding tool in the video codec based on the clipping range; and
reconstructing the one or more pictures based on the video codec with the coding tool configured according to the configuration.

14. The method of claim 13, wherein the clipping range is applied to input values of a prefiltering stage during an encoding of the sample values, the determining the configuration of the coding tool comprises:
determining a configuration of an in-loop filter for reconstruction in the video codec based on information of the clipping range.

15. The method of claim 13, wherein the clipping range is applied to output values of a prefiltering stage during an encoding of the sample values, the determining the configuration of the coding tool comprises:
determining a configuration of a motion compensation tool of the video codec based on information of the clipping range.

16. The method of claim 13, wherein a subject signal to be applied by a clipping operation has a dynamic range that is modified by a function, and the method comprises at least one of:
applying the clipping operation with the clipping range on the subject signal without a modification of the clipping range according to the function;
applying the clipping operation with a default clipping range on the subject signal; or
applying the clipping operation with a modified clipping range on the subject signal.

17. The method of claim 16, wherein the function includes at least one of a linear function and a non-linear function.

18. The method of claim 13, wherein the video codec uses an internal dynamic range corresponding to a first bitdepth that is higher than a second bitdepth used by input signals of the video codec, and the method comprises:
scaling up the clipping range to obtain a scaled clipping range having the first bitdepth; and
applying a clipping operation with the scaled clipping range on an internal signal of the video codec.

19. The method of claim 13, wherein the determining the clipping range comprises:
determining at least an unsigned value according to the one or more syntax elements in the coded video bitstream;
determining a sign for the unsigned value; and
determining the clipping range based on the unsigned value and the sign.

20. The method of claim 13, wherein the determining the clipping range comprises:
determining a first unsigned value and a second unsigned value according to the one or more syntax elements in the coded video bitstream;
determining to apply a first offset that is a combination of a positive sign with the first unsigned value to a minimal value of a predefined range to calculate a minimal value of the clipping range; and
determining to apply a second offset that is a combination of a negative sign with the second unsigned value to a maximal value of the predefined range to calculate a maximum value of the clipping range.

21. The method of claim 13, further comprising:
applying the clipping range on final values from a processing stage of the video codec, interim values within the processing stage not being clipped.

22. A method of processing visual media data, the method comprising:
processing a bitstream of visual media data according to a format rule, wherein:
the bitstream includes coded information of sample values of one or more pictures; and
the format rule specifies that:
at least a clipping range is determined according to one or more syntax elements in the bitstream, the clipping range being different from a fixed clipping range that is based on a bitdepth of a video codec for processing the sample values of the one or more pictures;
a configuration of a coding tool in the video codec is determined based on the clipping range; and
the one or more pictures are reconstructed based on the video codec with the coding tool configured according to the configuration.
